(19) United States
(12) Patent Application Publication
(10) Pub. No.: US 2018/0222455 A1
(43) Pub. Date: Aug. 9, 2018

(54) BRAKING SYSTEM WITH SECOND BRAKE

(71) Applicant: Mortada Hassan Ahmed ALDABOOS, Moon Township, PA (US)

(72) Inventor: Mortada Hassan Ahmed ALDABOOS, Moon Township, PA (US)

(21) Appl. No.: 15/427,089

(22) Filed: Feb. 8, 2017

(51) Int. Cl. B60T 7/22; F16D 55/228; F16D 65/18; B60T 8/171; B60T 8/172; B60T 8/58

(52) U.S. Cl. CPC B60T 7/22; F16D 55/228; F16D 65/18; F16D 2125/06; B60T 8/172; B60T 8/58; B60T 8/171

(57) ABSTRACT

A method and a braking system are described. The braking system includes a rotor connected to a wheel of the vehicle, a speed sensor measuring a vehicle speed, a first brake including a first piston and at least one brake pad coupled to the rotor, a second brake including a second piston and a brake pad coupled to the rotor, and a brake controller configured to activate the first piston to engage or disengage the first brake with the rotor, receive signal from the speed sensor to determine a stopping distance, compute a braking threshold based on the stopping distance, and activate the second piston to engage or disengage the second brake with the rotor based on the braking threshold.

### GRANT OF NON-EXCLUSIVE RIGHT

This application was prepared with financial support from the Saudi Arabian Cultural Mission, and in consideration therefore the present inventor(s) has granted The Kingdom of Saudi Arabia a non-exclusive right to practice the present invention.

### FIELD OF THE DISCLOSURE

This disclosure relates generally to improvements to a braking system of an automobile. More particularly the present disclosure relates to improvements relating to an additional brake that operates together with conventional brake of the braking system of an automobile to improve braking.

### BACKGROUND

A braking system of a vehicle can include a disc brake, a drum brake or a combination thereof attached to front wheels, rear wheels or both of the vehicles. Typically, a disc brake includes a brake pad connected to a rotor. In operation, the brake pads are pressed against the rotor to stop the vehicle via a hydraulic/pneumatic circuit including a piston and cylinder arrangement, and/or by wires connected to the brake pads.

The brakes are activated when a driver pushes on the brake pedal causing the vehicle to stop. A moving vehicle does not stop instantaneously upon application of the brakes, but travels a certain distance called a stopping distance, depending on the speed of the vehicle before coining to a halt. The stopping distance can be long when the vehicle is traveling at a high speed.

Certain situations can demand emergency braking and a shorter stopping distance. For example, when a person or an object suddenly appears on a road and there is not enough time to maneuver around the person or the object. Such emergency situations may require additional braking power.

Braking causes brake pads of the brakes to wear over time reducing the efficiency of the brakes. Also, worn-out brakes may take longer for the moving vehicle to stop. Thus, the brakes must be monitored regularly and replaced before the end of a brake life.

There remains a continuing need to provide improved braking performance of the vehicles at low cost. As such, it is desirable to extend the brake life. Also, there is a continuing demand to improve the stopping distance and response time of the brakes.

### SUMMARY

According to an embodiment of the present disclosure, there is provided a braking system apparatus. The braking system includes a rotor connected to a wheel of the vehicle; a speed sensor configured to measure a vehicle speed, a first brake including a first piston and at least one brake pad coupled to the rotor, a second brake including a second piston and at least one brake pad coupled to the rotor, and a brake controller. The brake controller is configured to activate the first piston to engage or disengage the first brake with the rotor, receive from a speed sensor, the measured vehicle speed, determine a stopping distance of the vehicle based on the measured vehicle speed, determine a second brake threshold for applying the second brake based on the stopping distance, determine whether the second brake threshold is reached, determine whether the second brake be engaged with the rotor, activate a second piston of the second brake to push the at least one brake pad of the second brake against the rotor, and release the second brake after the vehicle stops to disengage the at least one brake pad of the second brake from the rotor.

Further, according to an embodiment of the present disclosure, there is provided a method for applying a second brake. The method includes receiving from a speed sensor, a vehicle speed, determining a stopping distance of the vehicle based on the measured vehicle speed, determining a second brake threshold for applying a second brake based on the stopping distance, determining whether the second brake threshold is reached, determining whether the second brake be engaged with a rotor, activating, via brake controller, a second piston of the second brake to push at least one brake pad of the second brake against the rotor, and releasing the second brake after the vehicle stops to disengage the at least one brake pad from the rotor.

Further, according to an embodiment of the present disclosure, there is provided a non-transitory computer-readable medium which stores a program which, when executed by a computer, causes the computer to perform the method for applying a second brake, as discussed above.

The forgoing general description of the illustrative implementations and the following detailed description thereof are merely exemplary aspects of the teachings of this disclosure, and are not restrictive.

### BRIEF DESCRIPTION OF THE DRAWINGS

The accompanying drawings, which are incorporated in and constitute a part of the specification, illustrate one or more embodiments and, together with the description, explain these embodiments. The accompanying drawings have not necessarily been drawn to scale. Any values dimensions illustrated in the accompanying graphs and figures are for illustration purposes only and may or may not represent actual or preferred values or dimensions. Where applicable, some or all features may not be illustrated to assist in the description of underlying features. In the drawings:

FIG. 1A is a schematic of a braking system having a disc brake according to an exemplary embodiment of the present disclosure.

FIG. 1B is a side view illustrating a second brake in a disengaged state according to an exemplary embodiment of the present disclosure.

FIG. 1C is a side view illustrating a second brake in an engaged state according to an exemplary embodiment of the present disclosure.

FIG. 2A illustrates a second disc brake an outer rotor and an inner rotor according to an exemplary embodiment of the present disclosure.

FIG. 2B is a side view illustrating of the second brake of FIG. 2A with a second brake in a disengaged state according to an exemplary embodiment of the present disclosure.

FIG. 3 is a flow chart for braking control according to an exemplary embodiment of the present disclosure.

FIG. 4 is a block diagram illustrating a brake controller according to an exemplary embodiment of the present disclosure.

### DETAILED DESCRIPTION

The description set forth below in connection with the appended drawings is intended as a description of various embodiments of the disclosed subject matter and is not necessarily intended to represent the only embodiment(s). In certain instances, the description includes specific details for the purpose of providing an understanding of the disclosed embodiment(s). However, it will be apparent to those skilled in the art that the disclosed embodiment(s) may be practiced without those specific details. In some instances, well-known structures and components may be shown in block diagram form in order to avoid obscuring the concepts of the disclosed subject matter.

Reference throughout the specification to “one embodiment” or “an embodiment” means that a particular feature, structure, or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments. Further, it is intended that embodiments of the disclosed subject matter cover modifications and variations thereof.

It must be noted that, as used in the specification and the appended claims, the singular forms “a,” “an,” and “the” include plural referents unless the context expressly dictates otherwise. That is, unless expressly specified otherwise, as used herein the words “a,” “an,” “the,” and the like carry the meaning of “one or more.” Additionally, it is to be understood that terms such as “left,” “right,” “top,” “bottom,” “front,” “rear,” “side,” “height,” “length,” “width,” “upper,” “lower,” “interior,” “exterior,” “inner,” “outer,” and the like that may be used herein merely describe points of reference and do not necessarily limit embodiments of the present disclosure to any particular orientation or configuration. Furthermore, terms such as “first,” “second,” “third,” etc., merely identify one of a number of portions, components, steps, operations, functions, and/or points of reference as disclosed herein, and likewise do not necessarily limit embodiments of the present disclosure to any particular configuration or orientation.

Furthermore, the terms “approximately,” “proximate,” “minor,” and similar terms generally refer to ranges that include the identified value within a margin of 20%, 10% or preferably 5% in certain embodiments, and any values therebetween.

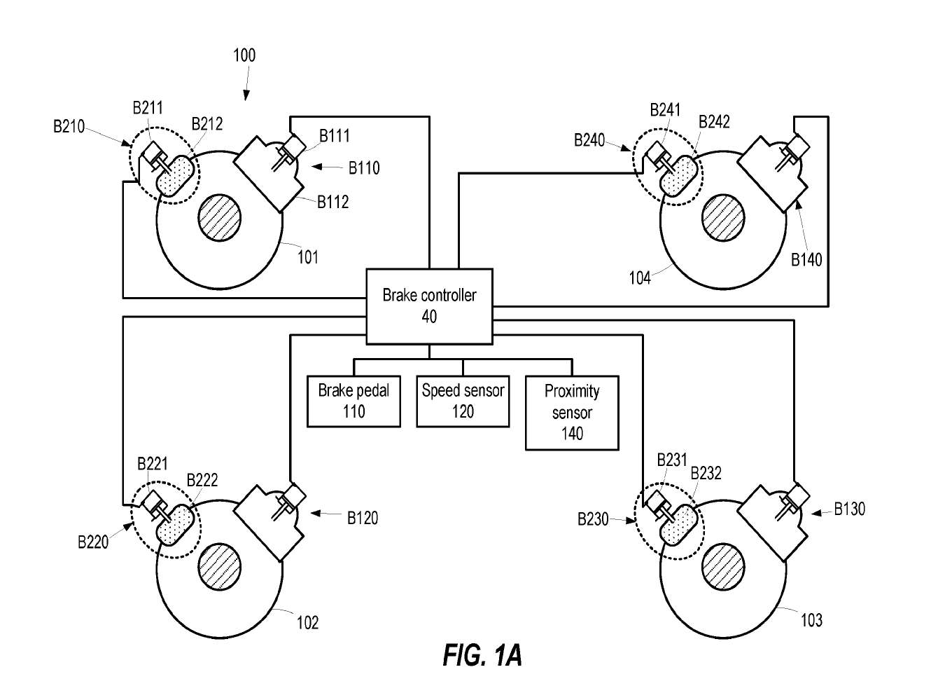

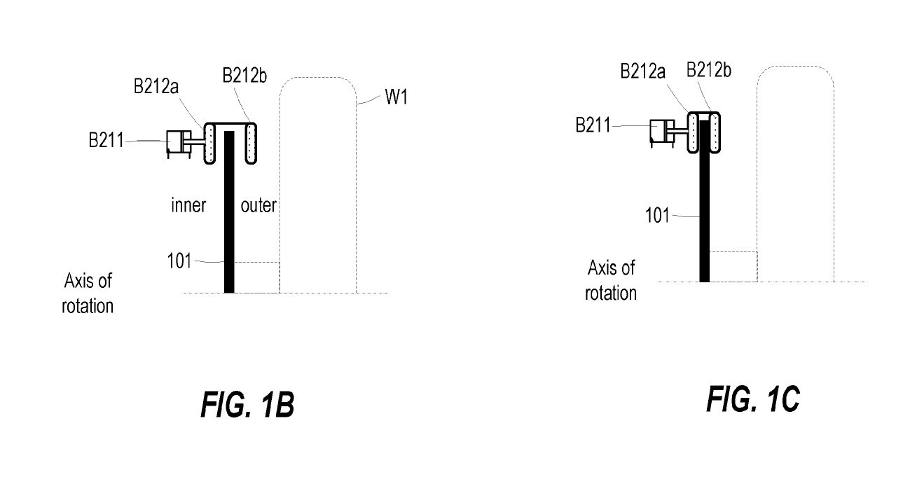

FIG. 1A is a schematic of a braking system having a disc brake 100 according to an exemplary embodiment of the present disclosure. The disc brake 100 includes a rotor 101, a first brake B110, a second brake B210, a brake controller 40, a brake pedal 110 and a speed sensor 120. Each wheel (not illustrated) of a vehicle can be fitted with the disc brake 100. For example, a four-wheel car can include the rotors 101, 102, 103, and 104, the first brakes B110, B120, B130, and B140, and the second brakes B210, B220, B230, and B240. The brake controller 40 can be configured to control the first brakes B110-B140 and the second brakes B210-B240 to stop a moving vehicle. Furthermore, the first brakes B110-B140 and the second brake B210-B240 can be controlled independently, in tandem or the second brake B210-B240 can be controlled in coordination with the first brakes B110-B140, or other possible combinations.

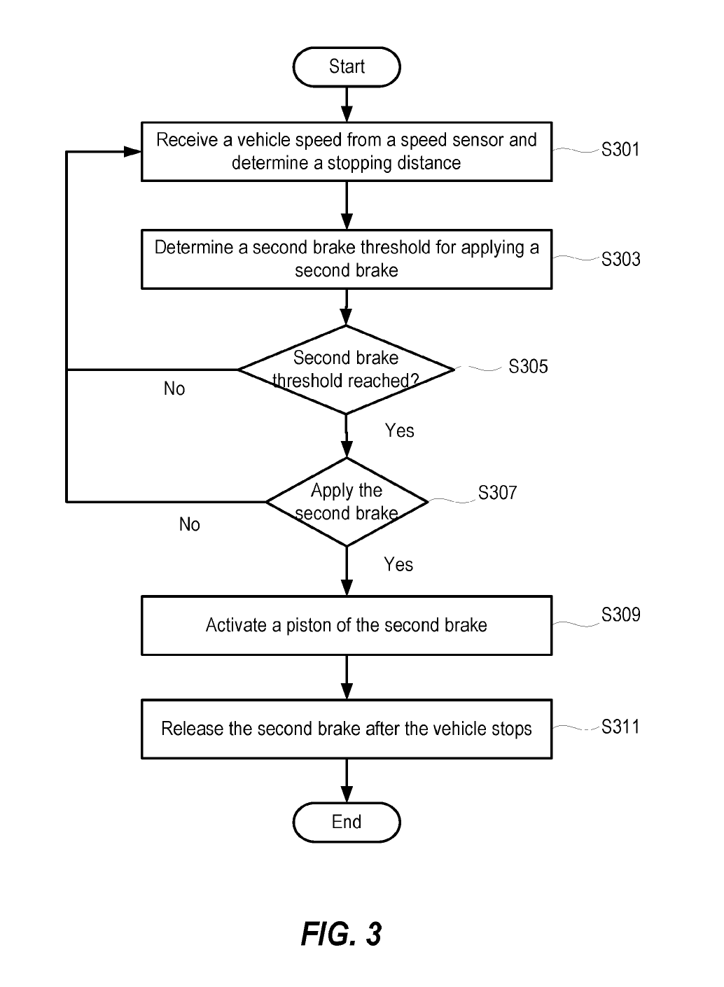

The speed sensor 120 can send a vehicle speed data to the brake controller 40. The proximity sensor 140 can send a distance between the vehicle and adjacent vehicle (at a front or back of the vehicle). The vehicle speed and the distance data can be used to compute a timing of applying the second brakes B210-B240, discussed in more detail with respect to FIG. 3.

The disc brake 100 can be configured to allow fast and efficient braking of a moving vehicle. The disc brake 100 can be configured to reduce a stopping distance, and minimize the wear of the first brakes B110-B140. For example, the stopping distance can be reduced by applying the first brakes B110-B140 and the second brake B210-B240 simultaneously. The wear of the first brakes B110-B140 can be reduced by applying the second brake B210-B240 after the speed of the vehicle has reduced by a certain percentage, e.g., 80% of an original speed of the vehicle.

The first brake B110 includes a first piston B111 and a brake pad (not illustrated) mounted in a first caliper B112. A caliper commonly refers to a brake assembly that fits over a rotor like a camp. The brake pad (not illustrated) can be lined with a friction material such as non-metallic, semi-metallic, metallic, or ceramic material. The brake pad is connected to the first piston B111 that can push the brake pad against the rotor 101. The rotor 101 can be a metallic disc commonly found in a disc brake of an automobile. As the brake pad rub against the rotor 101, the rotor 101 stops rotating gradually due to friction. Consequently, the vehicle stops.

Repeated use of the first brake B110 reduces the efficiency of the brakes and causes wear of the brake pad (and the rotor 101). Further, the brake pad can wear unevenly, reducing braking smoothness and making uneven contact between the first brake B110 and the first rotor 101. As such, the condition of the first brake B110 should be monitored regularly and replaced when the friction material thickness reaches a certain threshold such as less than approximately 5 mm or less than approximately 20% of an original thickness.

The first piston B111 refers to a piston cylinder arrangement commonly used in automotive brakes. The first piston B111 can be driven hydraulically, pneumatically, or by wires. The brake controller 40 can send signal to the first piston B111 to activate causing the rotor 101 to stop. The brake controller 40 can determine braking as a function of the speed of the vehicle, wear of the brake pads, a remaining life of the first brake B110, a total braking time (in hours) during the life of first brake B110, and other relevant factors. The process of braking implemented by the brake controller 40 is discussed in detail with respect to FIG. 3.

The second brake B210 includes a second piston B211 and a second brake pad B212, which can be mounted in a second caliper (not illustrated). Similarly, the second brakes B220, B230 and B240 can include second pistons B221, B231 and B241, respectively, and second brake pads B222, B232 and B242, respectively.

The second brake pad B212 is also lined with a friction material, similar the brake pad of the first brake B110. In one embodiment, the second brake B210 can be smaller in size and shape compared to the first brake B110. For example, the surface area of the brake pad B212 can be smaller than that of the brake pad of first brake B110. As such, adding the second brake B210 can be cost effective. Furthermore, the second brake B210 can be designed to wear faster or operate more frequently compared to the first brake B110, thus extending a useful life of the first brake B110.

In one embodiment, the brake pad B212 can have a friction material of a greater thickness compared to the brake pad of the first brake B110 allowing the second brake B210 to be applied more frequently. Consequently, the condition of the first brake B110 will deteriorate at a slow rate extending the useful life of the first brake B110.

In one embodiment, the brake pad B212 can include two pads B212a and B212b located on an inner side and an outer side, respectively, of the rotor as shown in FIGS. 1B and 1C. The outer side refers to a face of the rotor 101 facing a wheel W1, while the inner side refers to a face of the rotor 101 opposite to the wheel W1. FIG. 1B illustrates the second brake B210 in a release state (also referred as disengaged state) and does not contact the rotor 100. FIG. 1C illustrates the second brake B210 in a clamped state (also referred as engaged state) where the brake pads B21a and B212b contact the rotor 100.

In FIGS. 1B and 1C, the brake pad B212a is connected to the second piston B211. The second piston B211 can push the brake pads B212a and 212b against the rotor 101 simultaneously clamping the rotor 101. As the brake pads B212a and 212b rub against the rotor 101, the rotor 101 stops rotating gradually due to the friction. Consequently, the vehicle stops.

The second piston B211 is a piston cylinder arrangement commonly found in automotive brakes. The second piston B211 can be driven hydraulically, pneumatically, or by wires. The brake controller 40 can send signal to the second piston B211 to engage (or disengage) the brake pads B212a and B212b causing the rotor 101 to stop. The brake controller 40 can determine braking as a function of the speed of the vehicle, wear of the brake pads B212a and 212b, a remaining life of the second brake B210, a total braking time (in hours) during the life of second brake B210, factors related to the first brake B110, and other relevant factors. The process of applying the first brake B110 and/or the second brake B210 is implemented in the brake controller 40, discussed in detail with respect to FIG. 3.

The present disclosure is not limited to the above mentioned configuration of the first brake B110 and the second brake B210. Alternatively or in addition, the size, the shape, and the thickness of the friction material can be predetermined based on driving conditions, experimentation and testing for optimum brake performance, etc.

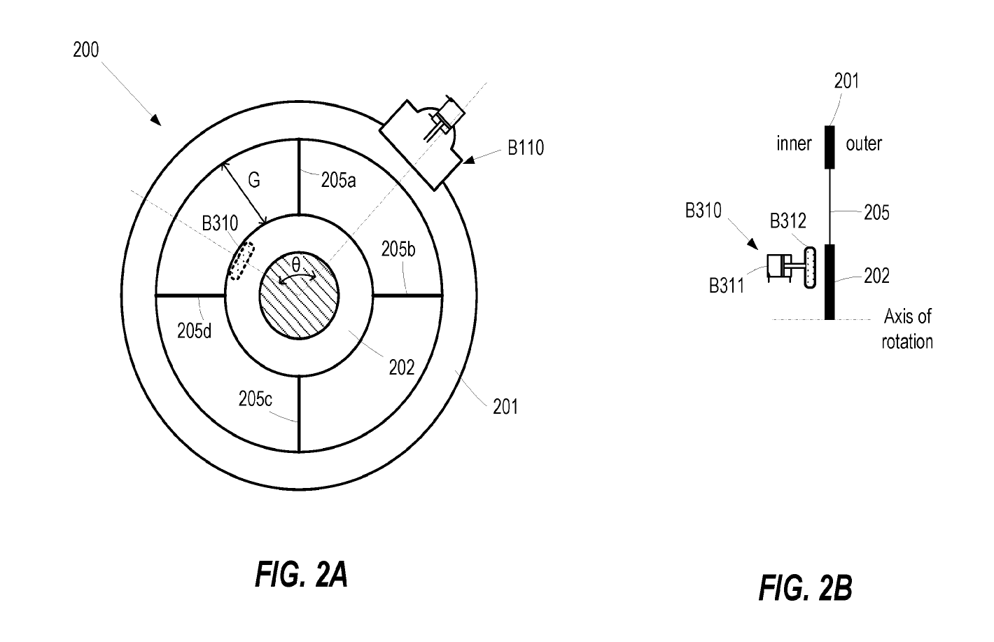

FIG. 2A illustrates a disc brake 200 with position of the second brake according to an exemplary embodiment of the present disclosure. The disc brake 200 includes two concentric rotors—an outer rotor 201 and an inner rotor 202. The outer rotor 201 and the inner rotor 202 can be connected by a set of spokes 205a-205d (collectively referred as 205). The outer rotor 201 and the inner rotor 202 rotate at the same speed. The outer rotor 201 is wide enough to couple the first brake B110 and the inner rotor 202 is wide enough to couple the second brake B310.

The second brake B310 can include one or more brake pads B312 coupled to with the second piston B211. The second brake B310 can be located at an angle θ relative to the first brake B110, or can be located radially along a same line relative to the first brake B110 (i.e., theta is θ). The second brake B310 can be include the brake pad B312 located at the inner side, as shown in the side view of the disc brake 200 in FIG. 2B. As such, the second brake B310 rubs against the inner rotor 303 only on the inner side. Placing the brake pad B312 on the inner side can allow easy access to the brake pad B312 for maintenance without removing a wheel of the vehicle. Alternatively or in addition, one or more brake pads can be located on the outer side of the inner rotor 202.

In operation, the second piston B311 can be activated by the brake controller 40 upon pressing on the brake pedal 110, as discussed with respect to FIG. 1A. The second piston B311 can push the brake pad B312 against the inner side of the inner rotor 201. The second piston B311 is located close to the axis of rotation, since a force acting perpendicular to the inner rotor 202 can cause the inner rotor 202 to wobble or deform.

The disc brake 200 with concentric rotors 201 and 202 can have several advantages. For example, the outer rotor 201 will not be heated due application of the second brake B310 and vice versa. Further, as the rotors 201 and 202 are separated by a radial gap G, air can be passed through the radial gap G to cool the rotors 201 and 202 and improve thermal efficiency of the braking. Additionally, as temperature has a negative effect on the brake life, improving the cooling of the rotors 201 and 202 can extend the brake life.

FIG. 3 is a flow chart for braking control according to an exemplary embodiment of the present disclosure. The braking control implemented in the brake controller 40 starts when a driver or a passenger pushes the brake pedal 110. Pushing the brake pedal 110 activates the first disc brake B110-B140 and the vehicle starts decelerating.

In step S301, the brake controller 40 receives a vehicle speed from a speed sensor 120. The brake controller 40 can time differentiate the vehicle speed to determine the rate of acceleration or deceleration. Based on the deceleration, a stopping distance can be computed. A stopping distance is a distance traveled by the vehicle after applying the brakes (i.e., pushing the brake pedal 110) until the vehicle comes to a complete halt. Additionally, the brake controller 40 can determine a physical distance between the vehicle and an object (e.g., an adjacent vehicle) using a proximity sensor data. The proximity sensor 140 can provide distance between the vehicle and an adjacent vehicle (at the front or back), for example.

In step S303, the brake controller 40 determines a second brake threshold for applying the second brake B210-B240. The second brake threshold can be a time-based or a distance-based measure at which the second brakes B210-B240 should be engaged. For example, the second brake threshold can be 3 s after applying the first brake B110-B140, or when the vehicle covers 50% of the stopping distance.

The second brake threshold can be computed using the speed sensor data, the deceleration, the proximity data, or a combination thereof. For example, the stopping distance (e.g., 15 m) between the vehicle and the adjacent vehicle can more than the physical distance (e.g., 10 m) between the vehicles. In such situation, the vehicle may collide with the adjacent vehicle. Thus, the second brake threshold can be set to 25% of the stopping distance. Engaging the second brake B210-B240 provides additional braking power that can decrease the stopping distance (e.g., from 15 m to 8 m), thus avoiding possible collision.

Alternatively or in addition, a time-based threshold can be applied. The time-based measure can be a pre-determined value to prevent excessive wear of the first brakes B110-B140. The time-based threshold can be pre-determined by experimentation and analyzing the wear data of the first brakes B110-B140 and/or the second brakes B210-B240. The time-based threshold can also be determined using the deceleration data computed in step S301. For example, if the deceleration is in the range 0-10 m/s², then the second brake threshold can be 2 s. If the deceleration is in the range 10-15 m/s², then the second brake threshold can be 3 s. And, if the deceleration is in the range 15-25 m/s², then the second brake threshold can be 4 s. Such a time-based measure can be pre-determined by experimentation as well.

In step S305, the brake controller 40 determines whether a second brake threshold is reached. The second brake threshold may or may not be reached depending on the speed of the vehicle, the deceleration, and/or the stopping distance. For example, the vehicle may stop before reaching the second brake threshold. If the second brake threshold is not reached, then the control returns to the step S301.

If the second threshold is reached, then in step S307, the brake controller 40 determines whether to apply the second brake B210-B240. The determination can be based on a condition (e.g., wear, broken, etc.) of the second brakes B210-B240 that can lend the second brakes B210-B240 to be inoperative. The wear-out of the first brakes B110-B140 and/or the wear-out of the second brakes B210-B240 can be excessive due to overuse or lack of maintenance. For example, the brake pads of the second brake B210-B240 can be worn-out to more than 70%, in which case the second brake B210-B240 may not be applied. The wear-out of the second brakes B210-B240 can be pre-determined during brake maintenance, or by tracking a total braking time of the second brakes B210-B240. The total braking time can related to a wear rate of the friction material of the brake pads. The wear rate can be determined experimentally for a particular friction material and a particular rotor used on the vehicle. If the second brake cannot be applied, then the control returns to the step S301.

If the second brake can be applied, then in step S309, the brake controller 40 activates the pistons B211-B241 of the second brakes B210-B240, respectively. In step S311, the brake controller 40 can release the second brakes B210-B240 after the vehicle stops.

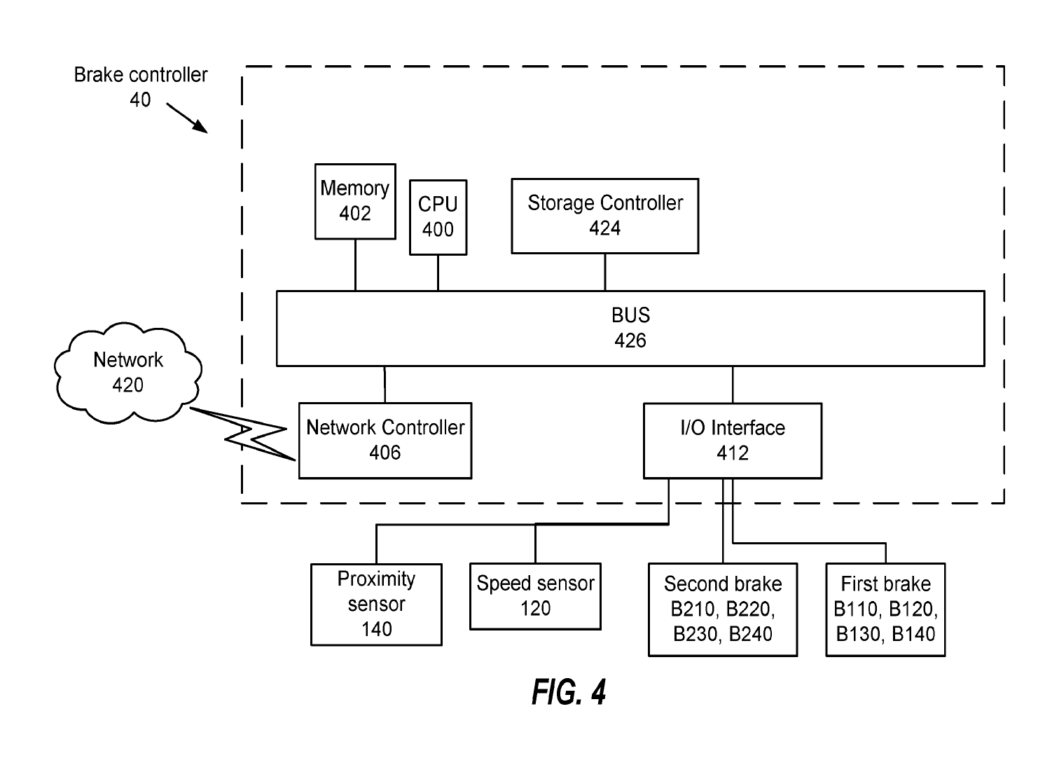

FIG. 4 is a block diagram illustrating the brake controller 40 according to an exemplary embodiment of the present disclosure. In FIG. 4, the brake controller 40 includes a CPU 400 which can be configured to receive inputs from the proximity sensor 140, the speed sensor 120, and process the data received from the from the proximity sensor 140, the speed sensor 120 to activate the first brakes B110-B140 and/or the second brakes B210-B240. The process data and instructions may be stored in the memory 402.

The hardware elements, in order to achieve the brake controller 40, may be realized by various circuitry elements, known to those skilled in the art. For example, CPU 400 may be a XENON or Core processor from INTEL of America or an Opteron processor from AMD of America, or may be other processor types that would be recognized by one of ordinary skill in the art. Alternatively, the CPU 400 may be implemented on an FPGA, ASIC, PLD or using discrete logic circuits, as one of ordinary skill in the art would recognize. Further, CPU 400 may be implemented as multiple processors cooperatively working in parallel to perform the instructions of the processes described above with respect to FIG. 3.

The brake controller 40, in FIG. 4, also includes a network controller 406 for interfacing with a network 420. Such network based interfacing can be useful to send commands, sensor data, or braking related data to an external device such as a server for analyzing the braking related data.

An I/O interface 412 interfaces with the proximity sensor 140, the speed sensor 120, the first brakes B110-B140, and the second brakes B210-B240 to send and receive inputs or to send activation/deactivation signals to the first brakes B110-B140, and the second brakes B210-B240.

The storage controller 424 connects the memory 402 with communication bus 426, which may be an ISA, EISA, VESA, PCI, or similar device, for interconnecting all of the components of the brake controller 40. A description of the general features and functionality of the storage controller 424, network controller 406, and the I/O interface 412 is omitted herein for brevity as these features are known.

While certain embodiments have been described, these embodiments have been presented by way of example only, and are not intended to limit the scope of the present disclosure. Indeed, the novel apparatuses and systems described herein can be embodied in a variety of other forms; furthermore, various omissions, substitutions and changes in the form of the apparatuses and systems described herein can be made without departing from the spirit of the present disclosures. The accompanying claims and their equivalents are intended to cover such forms or modifications as would fall within the scope and spirit of the present disclosure.

What is claimed is:

1. A braking system of a vehicle comprising:
a rotor connected to a wheel of the vehicle;
a speed sensor configured to measure a vehicle speed;
a first brake including a first piston and at least one brake pad coupled to the rotor;
a second brake including a second piston and at least one brake pad coupled to the rotor; and
a brake controller configured to
activate the first piston to engage or disengage the first brake with the rotor,
receive from a speed sensor, the measured vehicle speed,
determine a stopping distance of the vehicle based on the measured vehicle speed,
determine a second brake threshold for applying the second brake based on the stopping distance,
determine whether the second brake threshold is reached,
determine whether the second brake be engaged with the rotor,
activate a second piston of the second brake to push the at least one brake pad of the second brake against the rotor, and
release the second brake after the vehicle stops to disengage the at least one brake pad of the second brake from the rotor.

2. The braking system according to claim 1, further comprising:
a proximity sensor configured to measure an object distance between the vehicle and an object located at a front of the vehicle or at a back of the vehicle.

3. The braking system according to claim 2, wherein the brake controller is further configured to determine the stopping distance based on the measured object distance received from the proximity sensor, and compute the second brake threshold further based the measured object distance.

4. The braking system according to claim 3, wherein the second brake threshold is a time-based or a distance-based measure computed using data from the speed sensor and the proximity sensor further used to activate the second brake.

5. The braking system according to claim 4, wherein the time-based second brake threshold is computed using a deceleration rate of the vehicle determined using the measured vehicle speed.

6. The braking system according to claim 1, wherein the second brake includes a first brake pad coupled to an inner side of the rotor.

7. The braking system according to claim 6, wherein the second brake includes a second brake pad coupled to an outer side of the rotor.

8. The braking system according to claim 1, wherein the brake controller is configured to control the first brake and the second brake independently.

9. The braking system according to claim 1, wherein the rotor includes an outer rotor with the first brake coupled to the outer rotor and an inner rotor with the second brake coupled to the inner rotor to prevent heat generated from the first brake transferring to the second brake.

10. The braking system according to claim 8, wherein the at least one brake pad of the second brake is coupled to an inner side of the inner rotor to allow easy access to the at least one brake pad for maintenance without removing a wheel of the vehicle.

11. A method for braking a vehicle, the method comprising:
receiving from a speed sensor, a vehicle speed;
determining a stopping distance of the vehicle based on the measured vehicle speed;
determining a second brake threshold for applying a second brake based on the stopping distance;
determining whether the second brake threshold is reached;
determining whether the second brake be engaged with a rotor;
activating, via brake controller, a second piston of the second brake to push at least one brake pad of the second brake against the rotor; and
releasing the second brake after the vehicle stops to disengage the at least one brake pad from the rotor.

12. The method according to claim 11, further comprising:
receiving data from a proximity sensor; and
determining an object distance between the vehicle and an object based on the received data.

13. The method according to claim 12, further comprising:
determining the stopping distance based on the object distance measured using a proximity sensor.

14. The method according to claim 13, further comprising:
computing the second brake threshold further based the measured object distance.

15. The method according to claim 11, wherein the second brake threshold is time-based or a distance based measure computed using data from the speed sensor and the proximity sensor.

16. The braking system according to claim 14, wherein the time-based second brake threshold is computed using a deceleration rate of the vehicle determined using the measured vehicle speed.

17. A non-transitory computer-readable medium storing computer-readable instructions thereon which when executed by a computer, causes the computer to perform a method for braking a vehicle, the method comprising:
receiving from a speed sensor, a vehicle speed;
determining a stopping distance of the vehicle based on the measured vehicle speed;
determining a second brake threshold for applying a second brake based on the stopping distance;
determining whether the second brake threshold is reached;
determining whether the second brake be engaged with a rotor;
activating a second piston of the second brake to push at least one brake pad against the rotor; and
releasing the second brake after the vehicle stops to disengage the at least one brake pad from the rotor.
